(19) United States
(12) Patent Application Publication
(10) Pub. No.: US 2014/0023979 A1
(43) Pub. Date: Jan. 23, 2014

(54) REGENERATION OF AMELOBLAST CELLS AND DENTAL ENAMEL IN VIVO

(71) Applicant: Maha Mohamed Fouad MOUNIR, Alexandria (EG)

(72) Inventor: Maha Mohamed Fouad MOUNIR, Alexandria (EG)

(21) Appl. No.: 13/945,262

(22) Filed: Jul. 18, 2013

Related U.S. Application Data
(60) Provisional application No. 61/672,924, filed on Jul. 18, 2012.

(51) Int. Cl. A61C 19/06; A61D 5/00; A61C 5/04

(52) U.S. Cl. CPC A61C 19/063; A61C 5/04; A61D 5/00
USPC 433/1; 433/215; 433/224; 433/226

(57) ABSTRACT

A first aspect of the invention is related to a method for treating a subject's tooth that needs regeneration of dental enamel tissue and/or ameloblast cells. This method includes exposing at least a portion of crown, root canal or periapical tissue of the tooth and administering an enamel material in an amount sufficient to promote the regeneration of dental enamel tissue and/or ameloblast cells such that at least a portion of the exposed crown, root canal or periapical tissue is in contact with the enamel material. The invention is also related to a kits, compositions, and devices which can be used for the purposes of the present invention.

### CROSS REFERENCE TO RELATED PATENT APPLICATION

This application claims benefit of U.S. Provisional Patent Application Ser. No. 61/672,924, filed Jul. 18, 2012, which is hereby incorporated by reference in its entirety.

### FIELD OF INVENTION

The present invention generally relates to field of restorative dentistry and treating dental conditions, such as caries, and more particularly to methods, compositions, kits, and devices that promote regeneration of dental enamel and/or regeneration of enamel forming cells. The invention also relates to a special type of cells that can differentiate into enamel matrix and mature enamel.

### BACKGROUND OF THE INVENTION

Tooth enamel, along with dentin, cementum, and dental pulp is one of the four major tissues that make up tooth in humans, many other animals, and some species of fish. It makes up the normally visible part of the tooth, covering the crown. It is the hardest substance in the human body and contains the highest percentage of minerals, 96%, with water and organic material composing the rest. The primary mineral is hydroxyapatite, which is a crystalline calcium phosphate. Enamel is formed on the tooth while the tooth is developing within the gum and bone, before it erupts into the mouth. Once fully formed, it does not contain blood vessels or nerves or the cells forming the enamel and when damaged cannot be repaired by the body. The maintenance and repair of human tooth enamel is one of the primary concerns of dentistry.

Enamel does not contain collagen, as found in other hard tissues such as dentin and bone, but it does contain two unique classes of proteins—amelogenins and enamelins. The role of these proteins is not fully understood. Once mature, the enamel is almost totally devoid of softer organic matter. Enamel is avascular and has no nerve supply within it and is not renewed, however, it is not a static tissue as it can undergo mineralization changes.

The high mineral content of enamel, which makes this tissue the hardest in the human body, also makes it susceptible to a demineralization process which often occurs as dental caries, otherwise known as cavities. Demineralization occurs for several reasons, such as bacterial infection. Demineralization can lead to tooth cavities, which are also caused when acids dissolve tooth enamel. In addition to bacterial invasion, enamel is also susceptible to other destructive forces. Bruxism, also known as clenching or grinding of teeth, destroys enamel very quickly. Other nonbacterial processes of enamel destruction include abrasion (involving foreign elements, such as toothbrushes), erosion (involving chemical processes, such as dissolving by soft drinks or lemon and other juices), and possibly abfraction (involving compressive and tensile forces).

The health of a human tooth depends on the integrity of the dental hard tissues and the support of living soft tissues. Caries exposures are common and cause inflammation or death of the tooth pulp. These conditions are treated by procedures usually referred to as endodontic (or root canal) treatment. The root canal treatment itself and even more the following restorative procedures will remove a substantial amount of tooth structure. A significant advancement in endodontic treatment would be to support or restore enamel or the regenerative and repair properties of dental pulp, and treat any affected or necrotic areas. Thus, there is a great need for finding means for producing tissues that can differentiate into functional enamel forming cells and restoring lost enamel.

A survey of dental practices by the American Dental Association estimates that approximately 24 million root canal therapies are performed each year in the United States. With a very conservative average cost of $400 per treatment this represents $9.6 billion per year for endodontic therapy alone. The tooth structure then must be restored with available dental materials. The restorative costs are approximately 14.4 billion dollars for an average individual restoration cost of $600.

The present disclosure provides means to avoid/reduce these costs as well as to overcoming other deficiencies in the art.

### SUMMARY OF THE INVENTION

The present invention is related to a methods, kits, compositions, and devices which can be used for regenerating dental enamel tissue and ameloblast cells in organisms, such as, mammals. A first aspect of the invention is related to a method for treating a subject's tooth that needs regeneration of dental enamel tissue and/or ameloblast cells. This method includes exposing at least a portion of crown, root canal or periapical tissue of the tooth and administering an enamel material in an amount sufficient to promote the regeneration of dental enamel tissue and/or ameloblast cells such that at least a portion of the exposed crown, root canal or periapical tissue is in contact with the enamel material.

A second aspect of the invention is related to a kit for treating a subject's tooth that needs regeneration of dental enamel tissue and/or ameloblast cells. The kit includes an enamel material in an amount sufficient to promote the regeneration of dental enamel tissue and/or ameloblast cells and instructions for applying the enamel material to at least a portion of exposed crown, root canal or periapical tissue.

A third aspect of the invention is related to a device capable of treating a subject's tooth that needs regeneration of dental enamel tissue and/or ameloblast cells. The device includes a first chamber capable of holding enamel material; and a nozzle capable of delivering the enamel material to the subject's tooth.

A fourth aspect of the invention is related to a composition for treating a subject's tooth that needs regeneration of dental enamel tissue and/or ameloblast cells. The composition includes an enamel material and a pharmaceutically acceptable excipient.

The methods of the present invention include, for example, applying an effective amount of an enamel material to an infected coronal and/or apical regions of the tooth. This application of enamel material can be done after endodontic treatment.

### BRIEF DESCRIPTION OF THE DRAWINGS

FIG. 1 shows Nestin immunoreactivity (Nestin-IR) in root region (OM×100 of longitudinal section) six months after treatment with amelogenin. A regenerated enamel matrix shows strong Nestin-IR, while the cellular layer (shown by black arrows) overlying the regenerated matrix shows moderate Nestin-IR. Regenerated dentin that seals the apical area shows patches of Nestin-IR especially in the regenerated dentin. The regenerated pulp tissue 101 shows mild to moderate Nestin-IR. The odontoblast layer 103 shows strong Nestin-IR. The Figure also shows regenerated lateral root wall 102 of dentin. The enamel matrix is shown by white arrows.

FIG. 2A shows root region (H&E stain, OM×100 of longitudinal section) six months after treatment with amelogenin. It shows regenerated enamel matrix covering dentin. A thin enamel space that lies between the regenerated matrix and dentin is shown by black arrows. A thick cellular layer lining the regenerated enamel matrix is shown by white arrows. Regenerated pulp tissue 201 is also seen in the Figure.

FIG. 2B shows root region six months after treatment with amelogenin displaying Nestin immunoreactivity (OM×100 of longitudinal section). The regenerated enamel matrix shows strong Nestin-IR, while the cellular layer (shown by black arrow) overlying the regenerated matrix shows moderate Nestin-IR. The regenerated pulp tissue 201 shows mild to moderate Nestin-IR. The odontoblast layer 202 shows strong Nestin-IR. The white arrow shows regenerated enamel matrix.

FIG. 3A shows root region (H&E stain, OM×200 of longitudinal section) six months after treatment with amelogenin. The Figure shows regenerated enamel matrix covering the dentin. A mature enamel space lies between the regenerated matrix and dentin (black arrows). Tall columnar cells line the regenerated enamel matrix. A large vascular element (as shown by white arrow) lies in close proximity to the outer enamel epithelium.

FIG. 3B is a higher magnification micrograph of FIG. 3A (H&E stain, OM×400 of longitudinal section). It shows tall ameloblast cells with distal nuclei (as shown by black arrows) and the regenerated enamel matrix. A thin enamel space lies between the regenerated matrix and dentin. The white arrow shows a large vascular element that lies close to the outer enamel epithelium.

FIG. 4A shows root region (H&E stain, OM×100 of longitudinal section) six months after treatment with amelogenin. It shows the regenerated enamel matrix covering the dentin. A thin enamel space lies between the regenerated matrix and dentin (as shown by black arrow). Ameloblasts lines the regenerated enamel matrix (as shown by white arrow).

FIG. 4B shows root region (OM×100 of longitudinal section) treated with amelogenin, after six months, showing Nestin immunoreactivity. The regenerated enamel matrix shows strong Nestin-IR. The cellular layer overlying the regenerated matrix shows dense Nestin-IR specially the ameloblast cells and the nuclei of the rest of the enamel organ (as shown by black arrows). Ameloblasts lines the regenerated enamel matrix (as shown by white arrow).

FIG. 5 shows apical root region (H&E stain, OM×200 of longitudinal section) treated with amelogenin, after six months, showing regenerated tall columnar cells covering the regenerated dentin (as shown by black arrows). The Figure also shows regenerated dentin 501 in the apical region.

FIG. 6 shows a higher magnification of the micrograph of FIG. 5 showing tall ameloblast cells with distal nuclei covering the apical portion of the root (as shown by black arrows) (H&E stain, OM×400 of longitudinal section).

FIG. 7 shows a control. Apical and mid root area of teeth treated with calcium hydroxide are shown after 1 month. The Figure shows a widely opened apex and a complete lack of apical closure. Thin radicular walls (shown by black arrows), massive bone resorption at apical portion of the root is also seen. A thin layer of granulation tissue bridge the opened apex (as shown by white arrow). Trichrome stain, OM×40 of longitudinal section.

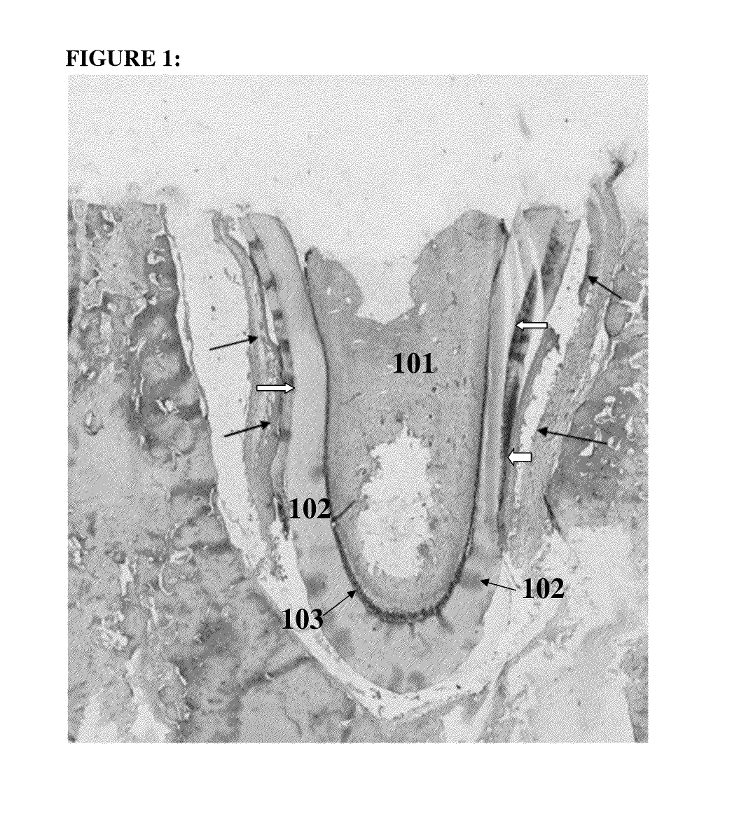

### DETAILED DESCRIPTION OF THE INVENTION

In the description that follows, citation is made to numerous references that may aid one of ordinary skill in the art to understand or practice of the invention in its fullest scope. Each such reference, as well as the references cited therein, is incorporated herein by reference to the extent needed to practice the methods or make the materials of the present invention, and to the extent such references do not conflict with the teachings of this invention, in which case the teachings of this invention are to be used to substitute or supplement such conflicting teachings in the incorporated references.

During tooth formation, epithelial-ectomesenchymal interactions (controlled by various signaling molecules) promote tooth morphogenesis. The primitive oral epithelium is induced to form the enamel organ. The enamel organ is formed of four cell types: external enamel epithelium, stelate reticulum, stratum intermedium, and internal enamel epithelium.

The whole enamel organ contributes to the formation of enamel.

Ameloblast cells are derived from the internal enamel epithelium of the enamel organ. The ameloblast cells commence formation of enamel after odontoblast cell, derived from the ectomesenchymal dental papilla, deposits dentin. The ameloblast cell first deposits organic matrix of enamel over the deposited dentin. The organic matrix of enamel has high enamel protein content. On enamel maturation, the enamel protein is degraded and influx of the mineral salt, the hydroxyl-apatite occurs. Mineral growth also takes place reaching up to 96%, i.e., enamel maturation. The ameloblast cells on completing the deposition of the tooth enamel become reduced in size and unite with the stratum intermedium, stelate reticulum, and external enamel epithelium to form “reduced enamel epithelium” that protects the fully mineralized dental enamel before the tooth eruption. On emergence of the tooth in the oral cavity, this reduced enamel epithelium unites with oral epithelium and uncovers dental enamel and becomes the attachment epithelium, thus the ameloblast cells are lost after the tooth eruption (J. K. Avery, Oral Development and Histology, Williams & Wilkins, Baltimore, Md. 1987; Moradian-Oldak J, Paine M L. Mammalian Enamel Formation. In: Sigel A, Sigel H, Sigel RKO, editors. Metal ions in life sciences. Chichester: Wiley; 2008; which are hereby incorporated by reference in their entirety).

Mature enamel does not contain cells and cannot remodel itself. The only alternative for repairing enamel is to create synthetic enamel for use as an alternative dental restorative material. The synthetic enamel is prepared in a laboratory in a cell-free system and depends on growing the enamel apatite crystals with similar organization to that of the natural enamel (Mann, “The Biommimetics of Enamel: A Paradigm for Organized Biomaterial Synthesis, Chi Chester, United Kingdom, John Willey and Sons Limited (1997); Slavkin HC, “Enamel Revisited,” Dimensions of Dental Hygiene 5(6):16-18 (2007), which are hereby incorporated by reference in their entirety).

It was previously assumed that the only potential method for regeneration of dental enamel is by using methods such as stem cell biology (Snead, “Whole-tooth Regeneration: It Takes a Village of Scientists, Clinicians, and Patients,” J. Dent Educ. 72:903-911 (2008); Athanassiou et al., “Ameloblast Potential of Human Dental Epithelial Stem Cells,” March 16-19; IADR General Session, San Diego-Calif. (2011), which are hereby incorporated by reference in their entirety) and/or the application of genes that are known to control the development of enamel forming cells (Caton et al., “Enamel-free Teeth: Tbx1 Deletion Affects Amelogenesis in Rodent Incisors,” Dev. Biol. 328: 493-505 (2009); Huang Z et al., “Bioactive Nanofibers Instruct Cells to Proliferate and Differentiate During Enamel Regeneration,” J. Bone Miner Res. 23:1995-2006 (2008), which are hereby incorporated by reference in their entirety). The efforts to regenerate enamel are ongoing, but remain at the level of laboratory investigations. This involves fabrication of a cell-free synthetic enamel to replace the conventional restorative materials (Moradian-Oldak J, “The Regeneration of Tooth Enamel,” Dimensions of Dental Hygiene, August; 7(8): 12-15 (2009), which is hereby incorporated by reference in its entirety).

Recently, neural crest cells NCC were reevaluated during mouse tooth development using NCC-specific transgenic mouse lineage. Inconsistent with traditional concepts, the potential contribution of NCCs to developing enamel organ and dental enamel formation was observed (Shih-Kai Wang et al., “Potential Contribution of Neural Crest Cells to Dental Enamel Formation,” Biochemical and Biophysical Research Communication 415:114-119 (2011), which is hereby incorporated by reference in its entirety). It has also been demonstrated that the PO-Cre transgene is specifically expressed in migrating NCC in the hindbrain region, where NCC contributes to tooth, validating their applicability for NCC lineage analysis.

Other studies for enamel regeneration (Snead, “Whole-tooth Regeneration: It Takes a Village of Scientists, Clinicians, and Patients.” J. Dent. Educ. 72:903-911 (2008); Athanassiou et al., “Ameloblast Potential of Human Dental Epithelial Stem Cells,” IADR General Session, San Diego-Calif. (2011); Caton et al., “Enamel-free Teeth: Tbxl Deletion Affects Amelogenesis in Rodent Incisors,” Dev. Biol. 328: 493-505 (2009); Huang et al., “Bioactive Nanofibers Instruct Cells to Proliferate and Differentiate During Enamel Regeneration,” J. Bone Miner. Res. 23: 1995-2006 (2008), which are hereby incorporated by reference in their entirety) use approaches such as cell cultures and cell reprogramming that are complex, expensive, and still not feasible.

The unanticipated and novel finding of the present invention may change the general understanding of tooth development and provide new insights into dental stem cell biology. The present invention provides a novel strategy for the regeneration of ameloblasts and tooth enamel. It relates to a surprising finding that amelogenin proteins can induce enamel regeneration. The methods of the present invention include applying effective amount of an enamel material to the infected coronal and/or apical regions of a subject's tooth after endodontic treatment.

The present invention also demonstrates for the first time that ameloblasts and dental enamel can be regenerated in fully erupted young permanent teeth. The use of recombinant amelogenin protein for inducing regeneration of enamel along with the attachment apparatus and the dental pulp is an important step towards whole tooth bioengineering and opens up new, previously remote, avenues for restorative dentistry.

A first aspect of the invention is related to a method for treating a subject's tooth that needs regeneration of dental enamel tissue and/or ameloblast cells. This method includes exposing at least a portion of crown, root canal or periapical tissue of the tooth and administering an enamel material in an amount sufficient to promote the regeneration of dental enamel tissue and/or ameloblast cells such that at least a portion of the exposed crown, root canal or periapical tissue is in contact with the enamel material.

In one embodiment, the present invention also envisions the use of stem cells or genes controlling the development of enamel forming cells along with the methods of the present invention.

In one embodiment, the methods of the present invention also include removing at least a portion of the existing tooth pulp. The portion of the removed tooth pulp can be inflamed, infected or necrotic. In another embodiment all of the existing tooth pulp is removed.

In one embodiment, the method includes regenerating dental enamel tissue by allowing sufficient time for the enamel tissue to grow in vivo. The method also includes permitting the regenerated enamel tissue to mineralize and form mature dental enamel. The time for the enamel tissue to grow in vivo can be in the range of 1 day to about two years. In one embodiment the time could be about 5 days to one year. In another embodiment, the time could be 10 days to 6 months. In another preferred embodiment, the time could be 3 months to 6 months. The time for permitting the regenerated enamel tissue to mineralize and form mature dental enamel can also be in the range of 1 day to about two years. In one embodiment the time could be about 5 days to one year. In another embodiment, the time could be 10 days to 6 months. In another preferred embodiment, the time could be 3 months to 6 months.

The methods of the present invention include regenerating ameloblast cells by allowing sufficient time for the ameloblast cells to regenerate in vivo. The time for regenerating ameloblast cells can be in the range of 1 day to about two years. In one embodiment the time could be about 5 days to one year. In another embodiment, the time could be 10 days to 6 months. In another preferred embodiment, the time could be 3 months to 6 months.

The methods of the present invention also include allowing the ameloblast cells to lay down a regenerated enamel matrix on the cervical and middle parts of the tooth's root. The methods of the present invention can include a step of applying a filling material to the exposed crown, root canal or the exposed periapical tissue. The filling material can be any material which is appropriate for tooth treatment or is routinely used in dentistry.

The tooth according to the present invention can be an infected permanent tooth. The tooth can be such that it has been endodontically treated.

In one embodiment the enamel material comprises amelogenin protein. The amelogenin protein can be a recombinant amelogenin protein. The amelogenin protein can be rM180 (see Snead M. L., et al., “Construction and Identification of Mouse Amelogenin cDNA Clones,” Proc. Natl. Acad. Sci. U.S.A. 80, 7254-7258 (1983); Moradian-Oldak., “Amelogenins: Assembly, Processing and Control of Crystal Morphology,” Matrix Biol. 20, 293-305 (2001); Gibson et al., “Amelogenin-deficient Mice Display an Amelogenesis Imperfecta Phenotype,” J. Biol. Chem. 276, 31871-31875 (2001); which are hereby incorporated by reference in their entirety). The amelogenin protein can be an isoform LRAP (see Fincham et al, “Dental Enamel Matrix: Sequences of Two Amelogenin Polypeptides,” Biosci Rep. 1(10):771-8 (1981), which is hereby incorporated by reference in its entirety).

Amelogenin is the name for a series of closely related proteins involved in amelogenesis, the development of enamel. They are a type of extracellular matrix (ECM) protein, which, together with ameloblastins, enamelins, and tuftelins direct the mineralization of enamel to form a highly organized matrix of rods, interrod crystal, and protein. Although the precise role of amelogenin(s) in regulating the mineralization process is unknown, it is known that amelogenins are abundant during amelogenesis. Developing human enamel contains about 30% protein, 90% of which are amelogenins.

The enamel matrix is composed of a number of proteins, such as amelogenins, enamelin, tuft protein, proteases, and albumin. Amelogenins, the major constituent of the enamel matrix, are a family of hydrophobic proteins derived from a single gene by alternative splicing and controlled post secretory processing. They are highly conserved throughout vertebrate evolution and demonstrate a high overall level of sequence homology among all higher vertebrates examined (approximately 80%). In fact, the sequences of porcine and human amelogenin gene transcript differ only in 4% of the bases.

The enamel material of the present invention can be such that it comprises full amelogenin or a fragment of amelogenin protein having 60 to 180 amino acids. Proteins, polypeptides, peptides and/or sub-fragments thereof, related to in this invention may be in a substantially isolated or purified form. It will be understood that the proteins, polypeptides, peptides and/or sub-fragments thereof may be mixed with carriers or diluents, which will not interfere with the intended purpose of the proteins, polypeptides, peptides and/or sub-fragments thereof and which will still be regarded as substantially isolated. Such a substantially purified form will generally comprise the protein, peptide and/or a fragment thereof in a preparation in which more than 90%, e.g. 95%, 96%, 97%, 98% or 99% of the protein in the preparation is a protein, polypeptide, peptide and/or fragment of the invention.

Furthermore, any amino acid sequence being at least 70% identical, such as being at least 72%, 75%, 77%, 80%, 82%, 85%, 87%, 90%, 91%, 92%, 93%, 94%, 95%, 96%, 97%, 98%, or 99% identical with the amino acid sequence of a protein, polypeptide peptide and/or sub-fragment of an active enamel substance comprising at least a fragment of amelogenin according to the invention, is also considered to be inside the scope of the present invention.

By a protein, polypeptide, peptide and/or fragment thereof having an amino acid sequence at least, for example 95% identical to a reference amino acid sequence of amelogenin, it is intended that the amino acid sequence of, e.g., the polypeptide is identical to the reference sequence, except that the amino acid sequence may include up to 5 point mutations per each 100 amino acids of the reference amino acid sequence. In other words, to obtain a polypeptide having an amino acid sequence at least 95% identical to a reference amino acid sequence: up to 5% of the amino acids in the reference sequence may be deleted or substituted with another amino acid, or a number of amino acids up to 5% of the total amino acids in the reference sequence may be inserted into the reference sequence. These mutations of the reference sequence may occur at the amino or carboxy terminal positions of the reference amino acid sequence or anywhere between those terminal positions, interspersed either individually among amino acids in the reference sequence or in one or more contiguous groups within the reference sequence.

In the present invention, a local algorithm program is best suited to determine identity. Local algorithm programs, (such as Smith-Waterman) compare a subsequence in one sequence with a subsequence in a second sequence, and find the combination of subsequences and the alignment of those subsequences, which yields the highest overall similarity score. Internal gaps, if allowed, are penalized. Local algorithms work well for comparing two multi-domain proteins, which have a single domain, or just a binding site in common.

Methods to determine identity and similarity are codified in publicly available programs. Preferred computer program methods to determine identity and similarity between two sequences include, but are not limited to, the GCG program package (Devereux, J et al (1994)) BLASTP, BLASTN, and FASTA (Altschul, S. F. et al (1990)). The BLASTX program is publicly available from NCBI and other sources. Each sequence analysis program has a default scoring matrix and default gap penalties. In general, a molecular biologist would be expected to use the default settings established by the software program used.

In one embodiment the methods include an enamel material which has about 1-50 mg/ml of amelogenin protein or a fragment thereof. The enamel material can also include a physiologically effective amount of at least one agent. The agent can be an agent that promotes regeneration of enamel tissue, an agent that promotes regeneration of ameloblast cells, an anti-bacterial agent, an anti-inflammatory agent, and a pharmaceutically acceptable excipient. The pharmaceutically acceptable excipient can be propylene glycol alginate.

The methods of the present invention also include a step of administering the enamel material which includes contacting the enamel material with periodontal ligament.

The amount of enamel material administered to the portion of crown, root canal or periapical tissue can be in the range of 0.05 mg/mm² to 5.0 mg/mm². In certain embodiments the enamel material has total protein content in the range of 0.05% w/w to 100% w/w.

The subject according to the present invention can be a mammal. In certain embodiments the subject is a human.

A second aspect of the invention is related to a kit for treating a subject's tooth that needs regeneration of dental enamel tissue and/or ameloblast cells. The kit includes an enamel material in an amount sufficient to promote the regeneration of dental enamel tissue and/or ameloblast cells and instructions for applying the enamel material to at least a portion of exposed crown, root canal or periapical tissue.

In one embodiment, the kit includes a device that is capable of delivering the enamel material to the subject's tooth.

A third aspect of the invention is related to a device capable of treating a subject's tooth that needs regeneration of dental enamel tissue and/or ameloblast cells. The device includes a first chamber capable of holding enamel material; and a nozzle capable of delivering the enamel material to the subject's tooth. The device according to the present invention can include a second chamber capable of holding a solvent wherein the solvent is capable of mixing with the enamel material.

In one embodiment, the present invention includes a syringe that has 2 inner compartments, one containing a lyophilized powder of amelogenin protein, while the other contains the solvent propylene glycol alginate (PGA). The powder and the solvent can be set up in the compartments such that they are separated and do not contact one another except during usage. When pressure is applied to the syringe, for example, by using a piston, both amelogenin powder and the solvent meet and are pushed outside the syringe. The syringe can be adapted such that it has a nozzle for delivering the mixture of amelogenin protein and the solvent to the root of the subject's tooth. For example, the nozzle can be in the form of a plastic tube or a needle that has the ability be placed in the root of the tooth and can reach the apical part of the root.

A fourth aspect of the invention is related to a composition for treating a subject's tooth that needs regeneration of dental enamel tissue and/or ameloblast cells. The composition includes an enamel material and a pharmaceutically acceptable excipient.

The enamel material includes amelogenin protein or a fragment thereof. The composition according to the present invention can also include a physiologically effective amount of at least one agent selected from a group consisting of an agent that promotes regeneration of enamel tissue, an agent that promotes regeneration of ameloblast cells, an anti-bacterial agent, an anti-inflammatory agent. In accordance to the present invention, compositions of the present invention include at least a fragment of amelogenin together with other active drug substances such as, e.g. anti-bacterial, anti-inflammatory, antiviral, antifungal substances or in combination with local chemotherapy, inducers of apoptosis, growth factors such as, e.g., TGFβ, PDGF, IGF, FGF, EGF, keratinocyte growth factor or peptide analogues thereof.

A composition comprising the enamel material can serve as a drug delivery system. In the present context the term “drug delivery system” denotes a pharmaceutical and/or therapeutic composition (a pharmaceutical and/or therapeutic formulation or a dosage form) that upon administration presents the active substance to the body of a human or an animal.

The enamel material also comprises pharmaceutically or cosmetically acceptable excipients. A pharmaceutically or cosmetically acceptable excipient is presently defined as a substance that is substantially harmless to the individual to which the composition is to be administered. Such an excipient normally fulfills the requirements given by the national health authorities. Official pharmacopoeias such as e.g. the British Pharmacopoeia, the United States of America Pharmacopoeia and The European Pharmacopoeia set standards for pharmaceutically acceptable excipients.

The choice of pharmaceutically acceptable excipient(s) in a composition for use according to the invention and the optimum concentration thereof cannot generally be predicted and must be determined on the basis of an experimental evaluation of the final composition. However, a person skilled in the art of pharmaceutical and/or therapeutic formulation can find guidance in e.g., “Remington's Pharmaceutical Sciences,” 18th Edition, Mack Publishing Company, Easton, 1990, which is hereby incorporated by reference in its entirety.

Throughout this application, various publications are referenced for more elaboration of the invention. It will be apparent for those skilled in the art that various modifications and variations can be made in the present invention without departing the spirit or scope of the invention, in addition, other embodiments of the invention will be apparent from considerations of the specification and practice of the invention disclosed herein. It is intended that the examples be considered as exemplary only, with a true scope and spirit of the invention being indicated by the following claims

### EXAMPLES

The following Examples are intended to be illustrative and in no way are intended to limit the scope of the present invention.

### Example 1

### Experimental Animals

All vertebrate animal studies were done after approval of the experimental procedures by an institutional review board for the safety and protection of vertebrate animals. A total of 240 root canals from 120 mandibular and maxillary premolars of twenty-four, 6-month old mongrel dogs were used.

### Example 2

### Recombinant Amelogenin Protein

Expression and purification of recombinant amelogenin was done using a polyhistidine amino-terminal tag. Expression vector pQE30 (QIAGEN Inc., Valencia, Calif.) was used as previously described by (Moradian-Oldak J, et al., “Self-assembly Properties of Recombinant Engineered Amelogenin Proteins Analyzed by Dynamic Light Scattering and Atomic Force Microscopy,” J Struct Biol 131(1):27-37 (2000), which is hereby incorporated by reference in its entirety.) Recombinant histidine tagged murine amelogenin (rp(H)M180) that is identical to the previously described recombinant mouse amelogenin (rM179) (Moradian-Oldak J, et al., “Self-assembly Properties of Recombinant Engineered Amelogenin Proteins Analyzed by Dynamic Light Scattering and Atomic Force Microscopy,” J Struct Biol 131(1):27-37 (2000), which is hereby incorporated by reference in its entirety) was used. An amino-terminal histidine tag peptide was added and used for affinity purification of the protein produced in bacteria. The entire DNA fragment within the pQE30 vector was subjected to nucleotide sequence determination to ensure that no errors were generated during the DNA amplification procedures and that each construct was correctly engineered. Recombinant proteins were prepared and purified using nickel-nitrilotriacetic acid (Ni-NTA) metal-affinity chromatography matrices (Qiagen, Valencia, Calif.).

### Example 3

### Apexification

Apexification treatment was performed in the premolar teeth of young permanent teeth. The recombinant mouse amelogenin protein (rp(H)M180), which is 180 amino acids in length, was used for apexification in experimental animals. Apexification treatment was performed in the premolar teeth of young permanent teeth. After endodontic access and determination of canal length, pulp tissue was removed with K-files. Hedstrom files were introduced to the radiographic apex and used in a filing action to remove all remnants of the pulp tissue.

### Example 4

### Root Canal Treatment

Root canal treatment was performed in the premolar teeth of permanent teeth. The recombinant mouse amelogenin protein (rp(H)M180), which is 180 amino acids in length, was used for apexification in experimental animals. After endodontic access and determination of canal length, pulp tissue was removed with K-files. Hedstrom files were introduced to the radiographic apex and used in a filing action to remove all remnants of the pulp tissue.

The canals were irrigated with distilled water and after hemostasis, a cotton pellet was placed in the entrance of each canal and the teeth were left without a coronal restoration for 14 days for the purpose of contamination. Subsequently, the canals were cleaned to the radiographic apices in the second visit, using larger files 1 mm short of radiographic apex, using gentle filing movements. The canals were irrigated with 1% sodium hypochlorite, dried with sterile paper points, and a cotton pellet with camphorated parachlorophenol was placed in the pulp chamber and sealed with temporary filling for 7-days. Infected teeth were excluded from the study. Teeth that showed no signs of infection on the third visit (e.g., no mobility, no bad odor, no purulent exudates, no draining sinus) were filled with recombinant amelogenin protein, rp(H)M180.

### Example 5

### Treatment with Amelogenin

Approximately 1 ml of propylene glycol alginate vehicle (PGA) was mixed with 50 mg recombinant amelogenin protein powder (rp(H)M180) which was pre-weighed by aseptic technique and left for 15 minutes before use. Once mixed, the material was used within 2-3 hours. The suspension of rp(H)M180+PGA material was injected into the canals with a special syringe. This was repeated until all of the premolars' root canals were filled.

### Example 6

### Histology and Immunodetection

Six months after treatment the animals were sacrificed and the status of the treated teeth assessed by routine histological and histochemical techniques (staining with H&E, Trichrome and Nestin antibody).

Tissues were fixed in freshly buffered formalin overnight and processed for paraffin embedding as previously described (Huang, et al. “Bioactive Nanofibers Instruct Cells to Proliferate and Differentiate During Enamel Regeneration,” J. Bone Miner. Res. 23: 1995-2006 (2008); Huang, “Biological Synthesis of Tooth Enamel Instructed by an Artificial Matrix,” Biomaterials 31:9202-11 (2010), which are hereby incorporated by reference in their entirety). Standard histologic procedures were used to prepare 3-6 μm thick sections that were stained using Hematoxylin and Eosin (H&E) or trichrome stains. Subsequently, immunodetection of Nestin was performed using anti-Nestin Rabbit monoclonal antibody obtained from Spring Bioscience, California (Product Catalog No. E18751). FITC conjugates secondary antibodies were obtained from Thermo Fisher Scientific, California (UltraVision Detection System Anti-Polyvalent, HRP/DAB; Product Catalog No. TP-015-HD) and used at a dilution of 1:2000. Sections were imaged using Ventanaiscan and/or Olympus DP 72 microscope with BX 51 digital camera (King Abdulaziz University laboratories) and a digital record was prepared.

Observations performed after a 6-month time period showed that a complete calcified tissue barrier was formed in root canals of the rp(H)M180 treated group, the regeneration of pulp tissue in which regenerated blood vessels and dentinal tissue were also recognized. Moreover, in the rp(H)M180 treated group, regenerated ameloblasts were observed covering the regenerated dentin in the apical area. Also, in the roots' cervical areas, the regenerated ameloblasts secreted enamel matrix in addition to maturation of the first secreted enamel matrix to mature enamel (enamel space after decalcification).

### Example 7

### Discussion

The present invention is novel strategy for the regeneration of ameloblasts and tooth enamel. It shows a surprising finding that amelogenin protein can induce enamel regeneration. This strategy can be used for treatment after a subject's tooth has caries, infection, and/or partial or complete pulp necrosis. The amelogenin protein can be applied to the infected coronal and/or apical regions after an endodontic treatment.

The amelogenin protein, in addition to stimulating the regeneration of the pulp and the dental attachment apparatus, is also capable of stimulating the regeneration of the enamel forming cells. The ameloblasts have the ability to lay down the organic matrix of dentin and mineralize this organic matrix. The origin of the regenerated ameloblasts can be a tissue that was related to the enamel organ during development, either the attachment epithelium or the epithelial rests of Mallasez, the remnants of Hertwig's Epithelial Root Sheath HERS, in the periodontal ligament.

The amelogenin protein is used to fill a widely opened root apex as a filling material and is inserted in the apical portion of an infected, endodonticaly treated tooth. It has been previously reported that amelogenin protein induces regeneration of dentin that will close the openedaex (U.S. Patent Application Publication No.: US 2011/0256495, which is incorporated by reference in its entirety). Regeneration of viable pulp tissue was observed and the regenerated dentin became attached to regenerated bone by a regenerated oriented periodontal ligament (U.S. Patent Application Publication No.: US 2011/0256495, which is incorporated by reference in its entirety). Recombinant amelogenin protein used in a U.S. Patent Application Publication No.: US 2011/0256495 induced pulp regeneration in vivo in addition to the regeneration of the whole attachment apparatus, resulting in the reattachment and the revitalization of the dead endodontically treated teeth. In the present invention the concentration of the recombinant amelogenin was increased. This allowed regeneration of ameloblast cells that secreted enamel matrix. The enamel matrix was subsequently mineralized to mature enamel. This result is outstanding and surprising.

In other words, the present invention, surprisingly, shows that when the concentration of amelogenin protein is increased, ameloblast cells are regenerated on the external surface of the whole root facing the regenerated periodontal ligament. The regenerated ameloblasts in the cervical root portion actively secreted enamel matrix as seen in H&E and Nestin staining. Nestin immuno-reactivity, that is a marker of neural stem cells or progenitor cells denoting embryonic neuro-epithelial stem cells, was observed in the regenerated ameloblasts, in the secreted enamel matrix and in the regenerated stratum intermedium, stelate reticulum and external enamel epithelium overlying the regenerated ameloblast cell layer.

Neuronal stem cell Nestin is one of the class VI intermediate filaments constituting the cytoskeleton. It is a marker of neural stem cells or progenitor cells. Its expression is also related to tooth development and repair of dentin. Nestin is expressed in the developing CNS in the early embryonic neuro-epithelial stem cells. This protein has been widely used as a predominant marker for stem/progenitor cells of mammalian CNS. Additionally, it is a superior angiogenic marker to evaluate neovascularity of the endothelial cells (Fujita et al., “Nestin Expression in Odontoblasts and Odontogenic Ectomesenchymal Tissue of Odontogenic Tumours,” J. Clin. Pathol. 59(3): 240-245 (2006), which is hereby incorporated by reference in its entirety).

Using Nestin antibody to stain the regenerated ameloblast cell layer and the regenerated enamel also showed a surprising finding. Strong Nestin-IR was noted in the ameloblast cells and the rest of the cells of the enamel organ. It is surprising that recently secreted enamel matrix shows dense Nestin-IR, while older enamel matrix shows less Nestin-IR. This may indicate degradation of the enamel matrix protein prior to mineral deposition and subsequent enamel maturation, which is seen as an enamel space.

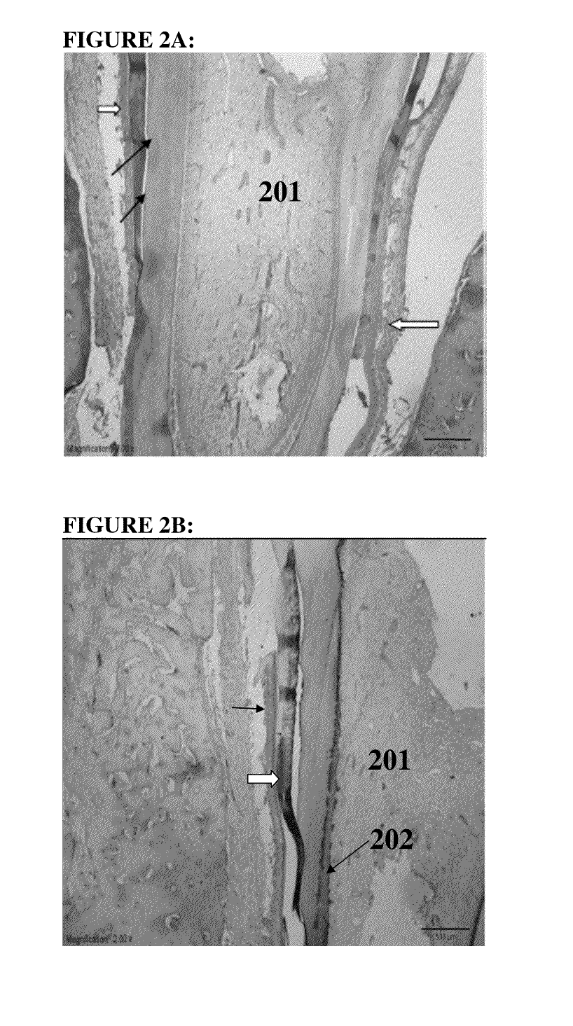

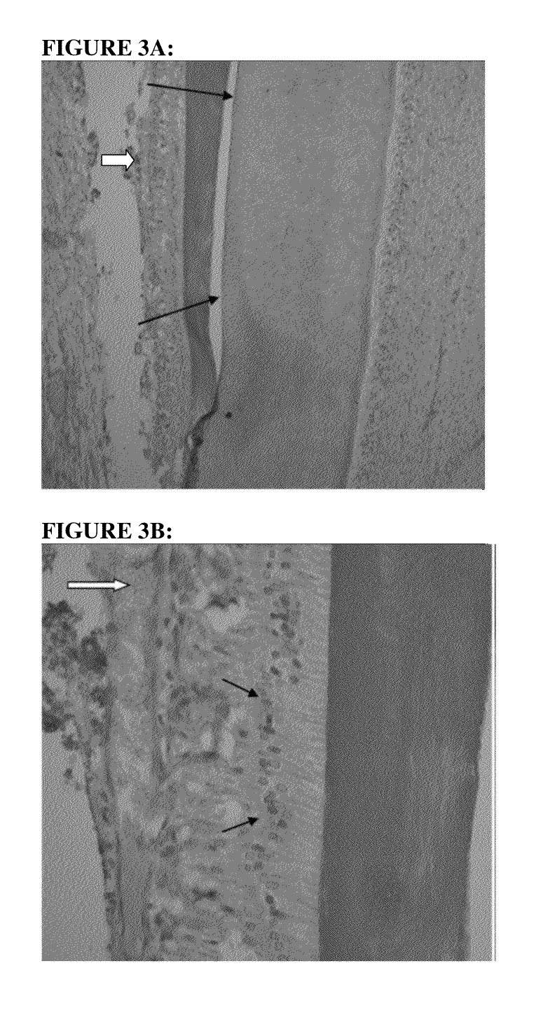

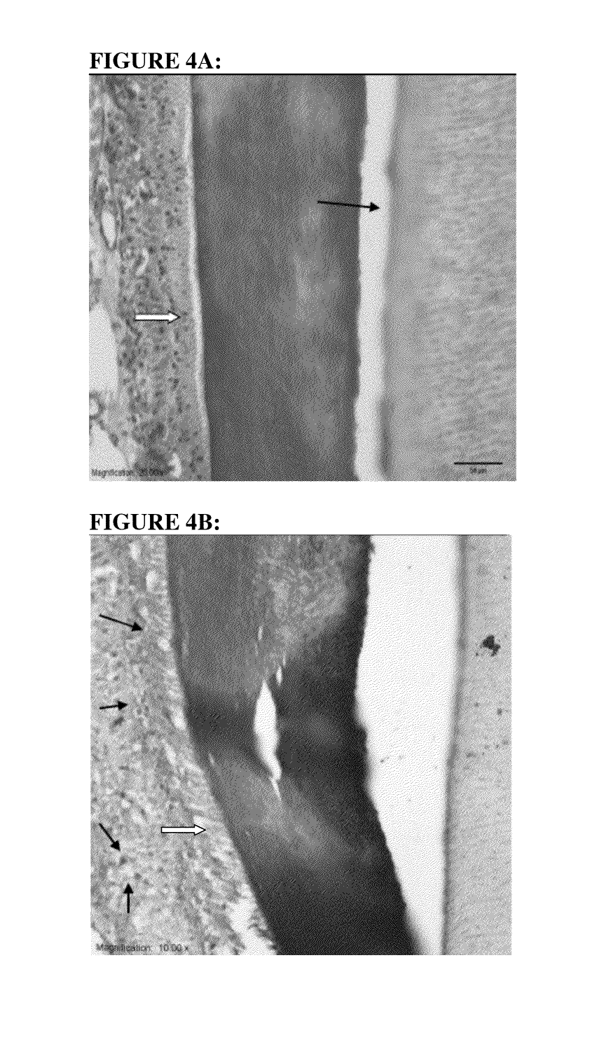

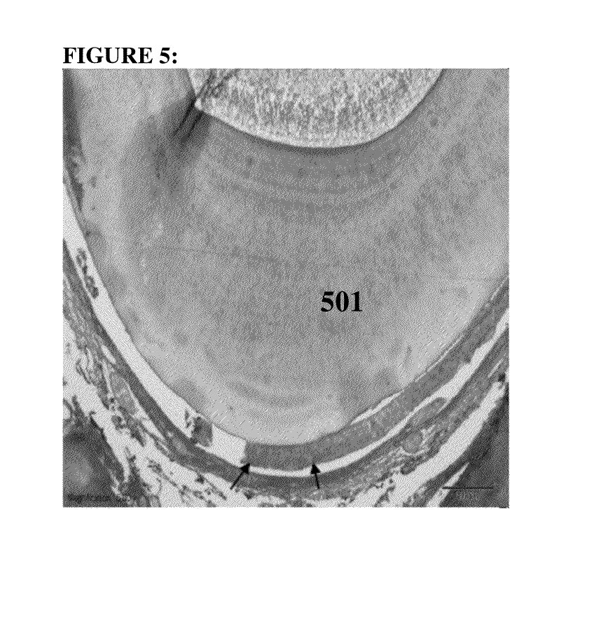

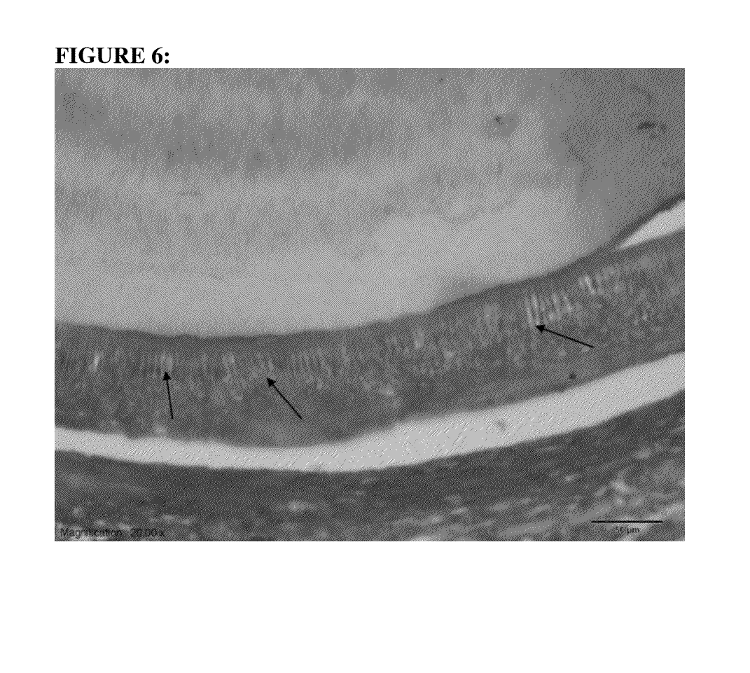

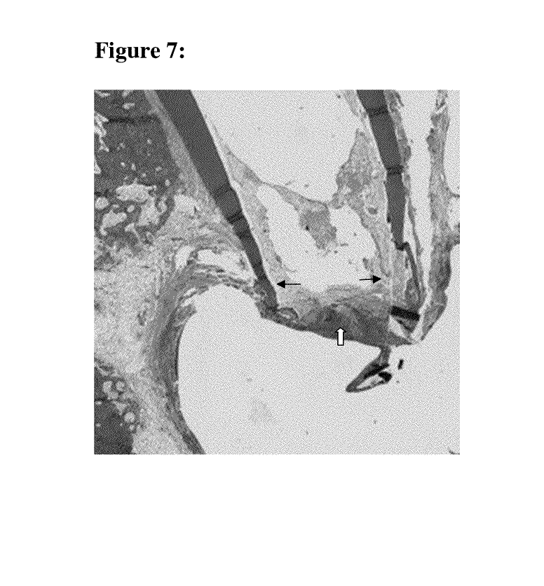

Another surprising result was that although ameloblast cells were regenerated on the external surface of the whole root (see FIGS. 2A and 5) the regenerated ameloblasts only secreted enamel matrix in the cervical parts and the middle parts of the root (see FIGS. 2A-B, 3A-B and 4A-B) The regenerated ameloblasts covering the root apex did not secrete enamel matrix.

Prior studies on dental regeneration were done using Enamel Matrix Proteins EMP which is a natural enamel protein of porcine origin (emdogain), and is composed of 90% amelogenins and 10% non-amelogenins. Emdogain has been used mainly for regenerative periodontal treatment; however, full periodontal regeneration was never achieved by using emdogain. As shown in the present invention, the use of a recombinant amelogenin protein resulted in periodontal regeneration as well as regeneration of ameloblast cells that secrete enamel matrix. The secreted enamel matrix is capable of forming mature enamel.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for treating a subject's tooth that needs regeneration of dental enamel tissue and/or ameloblast cells comprising:
exposing at least a portion of crown, root canal or periapical tissue; and
administering an enamel material in an amount sufficient to promote the regeneration of dental enamel tissue and/or ameloblast cells such that at least a portion of the exposed crown, root canal or periapical tissue is in contact with the enamel material.

2. The method according to claim 1, further comprising removing at least a portion of the existing tooth pulp of the tooth.

3. The method according to claim 2, wherein the portion of the removed tooth pulp is inflamed, infected or necrotic.

4. The method according to claim 1, further comprising regenerating dental enamel tissue by allowing sufficient time for the enamel tissue to grow in vivo.

5. The method according to claim 4, further comprising permitting the regenerated enamel tissue to mineralize and form mature dental enamel.

6. The method according to claim 1, further comprising regenerating ameloblast cells by allowing sufficient time for the ameloblast cells to regenerate in vivo.

7. The method according to claim 6, further comprising allowing the ameloblast cells to lay down a regenerated enamel matrix on the cervical and middle parts of the tooth's root.

8. The method according to claim 1, further comprising a step of applying a filling material to the exposed crown, root canal or periapical tissue.

9. The method according to claim 1, wherein the tooth is an infected permanent tooth.

10. The method according to claim 9, wherein the infected permanent tooth is endodontically treated.

11. The method according to claim 1, wherein the enamel material comprises amelogenin protein.

12. The method according to claim 11, wherein the amelogenin protein is a recombinant amelogenin protein.

13. The method of claim 11, wherein the amelogenin protein is rM180.

14. The method of claim 11, wherein the amelogenin protein is an isoform LRAP.

15. The method of claim 11, wherein the amelogenin protein is a fragment of amelogenin protein having 60 to 180 amino acids.

16. The method according to claim 11, wherein the enamel material comprises about 1-50 mg/ml of amelogenin protein.

17. The method according to claim 1, wherein the step of administering the enamel material comprises contacting the enamel material with periodontal ligament.

18. The method according to claim 11, wherein the enamel material further comprises of a physiologically effective amount of at least one agent selected from a group consisting of: an agent that promotes regeneration of enamel tissue, an agent that promotes regeneration of ameloblast cells, an anti-bacterial agent, an anti-inflammatory agent, and a pharmaceutically acceptable excipient.

19. The method according to claim 18, wherein the pharmaceutically acceptable excipient is propylene glycol alginate.

20. The method according to claim 1, wherein the amount of enamel material administered to the portion of crown, root canal or periapical tissue is in the range of 0.05 mg/mm² to 5.0 mg/mm².

21. The method according to claim 1, wherein the enamel material has total protein content in the range of 0.05% w/w to 100% w/w.

22. The method according to claim 1, wherein the subject is a mammal.

23. The method according to claim 22, wherein the subject is a human.

24. A kit for treating a subject's tooth that needs regeneration of dental enamel tissue and/or ameloblast cells comprising:
an enamel material in an amount sufficient to promote the regeneration of dental enamel tissue and/or ameloblast cells; and
instructions for applying the enamel material to at least a portion of exposed crown, root canal or periapical tissue.

25. The kit according to claim 24, wherein the enamel material comprises amelogenin protein.

26. The kit according to claim 25, wherein the amelogenin protein is a recombinant amelogenin protein.

27. The kit according to claim 25, wherein the amelogenin protein is rM180.

28. The kit according to claim 25, wherein the amelogenin protein is an isoform LRAP.

29. The kit according to claim 24, wherein the enamel material comprises a fragment of amelogenin protein having 60 to 180 amino acids.

30. The kit according to claim 25, wherein the amelogenin protein is present in the amount of about 1-50 mg/ml.

31. The kit according to claim 25, wherein the enamel material further comprises of a physiologically effective amount of at least one agent selected from a group consisting of: an agent that promotes regeneration of enamel tissue, an agent that promotes regeneration of ameloblast cells, an anti-bacterial agent, an anti-inflammatory agent, and a pharmaceutically acceptable excipient.

32. The kit according to claim 31, wherein the pharmaceutically acceptable excipient is propylene glycol alginate.

33. The kit according to claim 24, wherein the enamel material has total protein content in the range of 0.05% w/w to 100% w/w.

34. The kit according to claim 24, further comprising a device capable of delivering the enamel material to the subject's tooth.

35. A device capable of treating a subject's tooth that needs regeneration of dental enamel tissue and/or ameloblast cells comprising
a first chamber capable of holding enamel material; and
a nozzle capable of delivering the enamel material to the subject's tooth.

36. The device according to claim 35, further comprising a second chamber capable of holding a solvent wherein the solvent is capable of mixing with the enamel material.

37. The device according to claim 35, wherein the enamel material comprises amelogenin protein.

38. A composition for treating a subject's tooth that needs regeneration of dental enamel tissue and/or ameloblast cells comprising
an enamel material; and
a pharmaceutically acceptable excipient.

39. The composition according to claim 38, wherein the enamel material comprises a physiologically effective amount of at least one agent selected from a group consisting of: an agent that promotes regeneration of enamel tissue, an agent that promotes regeneration of ameloblast cells, an anti-bacterial agent, an anti-inflammatory agent.

40. The composition according to claim 38, wherein the enamel material comprises amelogenin protein.
